(19) United States
(12) Patent Application Publication
(10) Pub. No.: US 2005/0183060 A1
(43) Pub. Date: Aug. 18, 2005

(54) Automation tool

(75) Inventors: Werner Hoefler, Eckental (DE); Rafael Nunez-Furtado, Neustadt an der Aisch (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/980,926

(22) Filed: Nov. 3, 2004

Related U.S. Application Data
(63) Continuation of application No. PCT/DE03/01405, filed on May 2, 2003.

(30) Foreign Application Priority Data
May 3, 2002 (DE) 102 19 913.2

(51) Int. Cl. G06F 9/44

(52) U.S. Cl. 717/101

(57) ABSTRACT

An automation tool (12) for supporting the planning and implementation of an automated technical process (27) is provided. This tool includes access to a database (15) containing data (14) relating to a technical process (27) and depicts a user interface (11) with a data window (13) for displaying the data (14) and at least one working window (16, 17, 18) on a display device (10). The automation tool provides for individual data (14) to be depicted in the working window (16, 17, 18) and to be linked to data (14) in the data window (13).

This is a Continuation of International Application PCT/DE03/01405, with an international filing date of May 2, 2003, which was published under PCT Article 21(2) in German, and the disclosure of which is incorporated into this application by reference.

### FIELD AND BACKGROUND OF THE INVENTION

1. Field of the Invention

The invention relates to an automation tool to support the planning and implementation of automated technical processes.

2. Description of Related Art

Automation tools to support the planning and implementation of automated technical processes are generally known. Examples of automation tools of this type are CAD (Computer Aided Design) or CAE (Computer Aided Engineering) systems. Other examples of this automation tools are the so-called development environments, which are created e.g., to generate control programs for controlling and/or monitoring technical processes.

A drawback of these prior art automation tools is that every automation tool accesses its own database. This requires a time-consuming transfer of the data of the individual automation tools, particularly if a number of different automation tools are successively used to plan and implement automated technical processes. Even after this transfer of data from a first to a second automation tool, there is no content-based or functional connection between the data. Each user of an automation tool must deal with the full data volume and is responsible for the correct use and processing of the data within his or her scope of duties without always knowing the specific origin, context, or functionality of the individual data.

Before a product or a workpiece can be automatically produced, a significant amount of time and effort must be invested in setting up the automated production process for this product or workpiece. To set up this production process, specialists are required, i.e., production and automation specialists—hereinafter referred to as designers or automation specialists. These specialists receive specifications from other specialists—hereinafter referred to as technologists—who define the characteristics of the product.

The technologist is the planner of a product and generates, for example, the formula of a drug or the model of a motor vehicle in the form of individual body parts with welds or other connecting points. The technologist essentially thinks in terms of product characteristics, market factors, competition, economic efficiency, etc. Other important factors influencing the technologist are criteria such as production times, production costs, and product innovations.

The designer is the planner of the production installation. The designer specifies machines and equipment to mix and chemically or thermally influence the precursor materials of the drug or to transport, handle, and interconnect the body parts. The designer essentially thinks in terms of physical processes or physical quantities. The designer considers items such as plant parts, (pipe) lines and substances or their movements or mobility.

The automation specialist plans the automation of the resulting technical process. The automation specialist creates a control program to influence the machines or equipment, the transport and processing of the starting materials or products to ultimately produce the end product. The automation specialist essentially thinks in terms of digital quantities and final states or smaller, independent units.

In planning the automation of the resulting technical process, the automation specialist considers control functions, time sequences, drives and driving means, positions of moved or movable components in the process and states of the process. The automation specialist is familiar with the so-called state graphs and is used to dividing the technical process into separable partial processes, with which the automation specialist deals successively. The automation specialist's way of thinking is therefore less oriented towards the overall context of the technical process.

Extensive coordination is required among the individual specialists. This coordination takes place at least between the technologist and the designer on the one hand and the designer and the automation specialist on the other. Distributing the tasks among several specialists who have different ways of thinking and who until now have each used different automation tools for their scope of responsibilities results in substantial problems. Only a few of these problems will be identified below by way of example.

First and foremost, communication problems occur among the specialists involved. This is essentially due to the different language they use. Hence, communication primarily involves translated information, i.e., the designer, when trying to draw the automation specialist's attention to specific features of the mechanical system, attempts to think like the automation specialist and explain the problem in the automation specialist's language. If the designer fails to do this translation but uses his or her language to describe the problem to the automation specialist, the automation specialist translates what he or she has heard or read into his or her way of thinking. The example can of course be expanded to include every possible and meaningful communication among the specialists involved.

The consequence of this continuously required translation of information is a loss of information. For example, the designer may not, or only incompletely or incorrectly relay information to the automation specialist that he or she received from the technologist and that is not particularly important to him or her. This loss of information necessarily leads to inconsistencies in the data used.

### OBJECTS OF THE INVENTION

One object of the present invention is thus to provide an automation tool that can be used to establish a content-based and functional connection among the data relating to the respective technical process, which remains linked to the data, such that a link established by a first specialist who is entrusted with the planning and implementation of the technical process will remain recognizable to other specialists as well.

Another object of the present invention is to prevent these losses of information.

Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

### SUMMARY OF THE INVENTION

According to an illustrative, non-limiting formulation of the present invention, an automation tool for supporting the planning and implementation of an automated technical process is provided. The automation tool, on the one hand, includes access to a database containing a plurality of data relating to the technical process and, on the other hand, displays a user interface with a data window for displaying the data and at least one working window on a display unit. The specific data related to the technical process can be displayed in the working window and linked with data in the data window.

In according with the exemplary formulation, all the specialists use the same database in describing the technical process or their contribution to the solution of the automation problem. This database includes a plurality of data, and each datum relates to a component or an aspect of the technical process. Components of the technical process are, for example, containers, pipelines, etc., motors, valves, etc., control elements, limit switches, etc. and automation devices, e.g., programmable controllers and/or decentralized peripheral devices. Aspects of the technical process relate to, for example, the capacity of the individual components of the technical process to be influenced or controlled.

For the individual specialists, however, only a subset of these data is typically relevant. Each specialist is presented with precisely the data that are relevant for him or her in a working window provided for this individual specialist. Each specialist then links the data displayed in his or her working window with other data in the data window. This establishes a content-based and functional connection between individual data of the technical process.

By way of an example, if a certain surface finish is specified for a workpiece, the fact that this finish is required is encoded in a respective datum of the database. The type of finish is encoded in the same, or optionally in an additional datum. These data of the technical process are usually specified by the technologist, who largely decides on the type and the appearance or the functionality of the workpiece. The designer, based on the data displayed in the data window, recognizes the need for a device to polish the workpiece in the technical process. Thus, the designer creates a datum in the working window provided for him or her to represent such a polishing device. Once the datum has been created in the working window, it is part of the database and can therefore be displayed in the data window. If the designer or the technologist now links the datum representing the polishing device with the one or each datum encoding the polishing, a configuration of the polishing device is achieved. The data are thus no longer presented independently and in parallel, but are interlinked on the basis of the concrete technical process.

In an illustrative, non-limiting formulation of the present invention, a datum may consist of a simple data type, e.g., a byte, word, integer, etc., or a composite and/or user-defined data type. Composite data types are feasible in almost any combination. These data types are composed of simple data types and/or composite data types that have already been defined.

The above-described creation of a datum to represent a polishing device can also be generated automatically, i.e., if the data encoding the polishing can be used to automatically infer the requirement of the polishing. For example, if the data encoding the polishing are instances of a special data type, particularly a special object type.

The recognition of structures created by these data and the automatic derivation of information from these recognized structures, i.e., additional data, is preferably accomplished, for example, using the method described in the German patent application titled: “Automatisierungswerkzeug zur Unterstützung einer Planung und Realizierung eines Automatisierten Technischen Prozesses und Korrespondierendes Verfahren” (Automation tool for supporting the planning and implementation of an automated technical process and method therefor), filed on May 3, 2002 for Siemens AG (serial number: 102 19 912.4), incorporated herein by reference.

In an illustrative, non-limiting formulation of the present invention, the at least one working window is preferably provided to display data relevant for a technologist, a designer or an automation specialist. Each specialist can then use the working window provided for this particular specialist to link the data displayed in the working window with data displayed in the data window based on his expertise.

The data in the working window are linked with data in the data window by selecting the datum in the working window using a pointer device, e.g., a mouse or the like, and moving the selected datum onto the datum to be linked in the data window, or by selecting the datum in the data window using the pointer device and moving the selected datum onto the datum to be linked in the working window. This process of selecting an object, moving the object and releasing the selection of the object is usually referred to as “drag and drop” approach. Linking data by “dragging and dropping” the data in the automation tool results in an intuitive use for the specialists so that the automation tool can be used quickly, without a lengthy familiarization period.

According to an exemplary, non-limiting formulation of the present invention, it is preferable to adjust the suppression of the display of data irrelevant for a technologist, designer or automation specialist in the data window, so that the data volume displayed in the data window can be appropriately reduced. This makes the display clearer and thereby prevents, for example, incorrect or accidental linking.

A display of selected data in the data window or working window is also referred to as a view. According to an exemplary, non-limiting formulation of the present invention, it is preferable for the data window and the one or each working window, a plurality of views is feasible and meaningful, such that each specialist, in addition to the default views, can define his or her own views based on his or her requirements. For each specialist, a plurality of views can be defined to divide the technical process, e.g., spatially or functionally.

The views for presenting only the relevant data to the given specialist are preferably specified and selected, e.g., in the manner described in the German application titled: Automation tool, filed on May 3, 2002 for Siemens AG (serial number: 102 19 911.6), incorporated herein by reference.

Further advantageous embodiments of the present invention may thus also result from combining features thereof with aspects of the two abovementioned applications.

### BRIEF DESCRIPTION OF THE DRAWINGS

The present invention will now be described in detail by describing illustrative, non-limiting embodiments thereof with reference to the accompanying drawings. In the drawings, the same reference characters denote analogous elements:

FIG. 1 shows a screen display of an automation tool according to an illustrative, non-limiting embodiment of the present invention,

FIG. 2 is an example of an item to be produced in an automated technical process according to an illustrative, non-limiting embodiment of the present invention,

FIG. 3 is a schematic representation of a technical process according to an illustrative, non-limiting embodiment of the present invention, and

FIG. 4 is a schematic representation of an automation system to control and/or monitor the technical process according to an illustrative, non-limiting embodiment of the present invention.

### DETAILED DESCRIPTION OF ILLUSTRATIVE, NON-LIMITING EMBODIMENTS

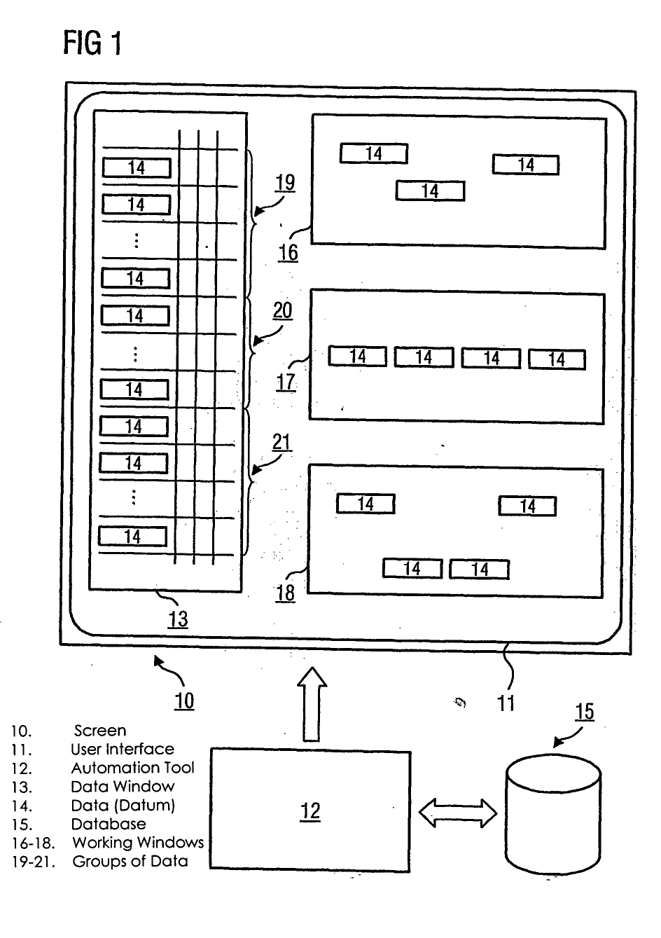

FIG. 1 shows a schematically depicted screen 10 with an operator or user interface 11 as a display device of an automation tool 12. The automation tool 12 is indicated only schematically. The automation tool is implemented as a software application in a known manner. As a software application, the automation tool 12 is stored in a memory (not depicted) of a computer (not depicted) to be used in and to support the planning and implementation of any automated technical process in a known manner.

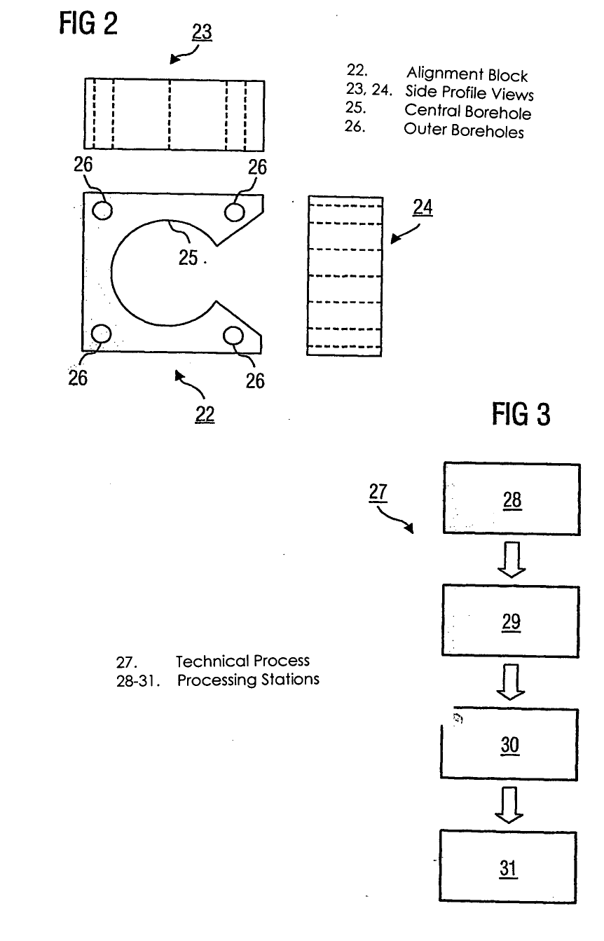

The user interface 11 includes a data window 13 to display data 14 relating to a technical process. The technical process can be any automated process or any process that should be automated. The use of the automation tool 12 for an exemplary technical process will now be described with reference to FIGS. 2-4. The data 14 are centrally stored in a database 15, which the automation tool 12 can access (indicated by a block arrow). The database 15 is provided by way of an example, and other data stores are clearly within the scope of the invention. The automation tool 12 causes all the data or selected data 14 to be displayed in the data window 13 (likewise indicated by a block arrow). By way of an example, together with the data 14 (indicated in the figure only by a table structure next to the data), individual attributes assigned to the respective datum 14 can be displayed, as described in the German application 102 19 911.6 of Siemens AG.

The user interface 11 further includes at least one working window. In the example depicted in FIG. 1, the user interface 11 has three working windows 16, 17, and 18. Each working window 16, 17, and 18 is assigned to a specialist involved in implementing the automation of the technical process. A first working window 16 is provided, for example, for a technologist. A second and third working window 17 and 18 are provided, for example, for a designer and an automation specialist, respectively. Since out of the total data volume 14 stored in the database 15 only a subset of the data 14 is typically relevant for each specialist, only the data relevant for that specialist are presented in the working window 16, 17, and 18.

For example, FIG. 1 shows that only three datum 14 are provided for the technologist in the working window 16, four datum 14 (which may be the same datum or different datum from the ones presented in the working window 16) are provided for the designer in the working window 17, and four datum 14 are provided for the automation specialist in the working window 18.

Based on the specialist's expertise and contribution to the automation of the technical process and of course based on the technical process itself, each of the specialists establishes links between data 14 in the respective working window 16, 17, and 18 and the data 14 in the data window 13. The data 14 in the data window 13 can be grouped for a clearer presentation. For example, a first group 19 combines data 14 regarding the technical process, which are more technology-related. Accordingly, the technologist may use only data 14 in the first group 19, where other data 14 are suppressed. Second and third groups 20 and 21, each contain data 14 which are more design-related or automation-related. This grouping of the data 14 provides a simple way to suppress the display of data 14 that are not relevant for a particular specialist, i.e., a technologist, a designer, or an automation specialist. A display of data 14 can also be suppressed using the attributes assigned to the data 14.

The data 14 are linked by selecting a datum 14, e.g., in a working window 16, 17, or 18 and using a pointer device, e.g., a mouse, to move the selected datum 14 in a working window 16, 17, or 18 onto a datum 14 in the data window 13 where it is released. This operation, which is referred to as “drag and drop,” is widely used in graphic user interfaces. The data 14 can also be linked starting from the data window 13 by dragging the selected datum 14 onto a datum 14 in a working window 16, 17, or 18. In addition, the data 14 can be linked by manual assignment, e.g., by selecting the datum 14 such that a contextual menu appears with an input field, in which the datum 14 can be linked, or by entering a reference to this datum 14 in the provided input field.

FIG. 2 shows an exemplary item that is to be produced in an automated technical process. In the example depicted in FIG. 2, the exemplary item is an alignment block 22, shown in top view and also in a first and a second side profile view 23 and 24. The alignment block 22 was designed in a known manner e.g., using a CAD system (CAD=Computer Aided Design). Thus, all the dimensions of the alignment block 22 are available in the form of data of the CAD system. Out of all the data describing the complete shape of the alignment block 22, a few data are now selected by way of example as described below.

FIG. 2 illustrates the alignment block 22 having central borehole 25 and four outer boreholes 26. The positioning of these boreholes 25 and 26 in the CAD view of the alignment block 22 already defines their dimensions (radius and possibly depth) and their position, thereby providing some of the dimensions of the alignment block 22. With reference to the central borehole 25, these dimensions of the central borehole 25 define the drilling tool to be used i.e., the radius of the drilling tool and the position on the alignment block 22 where the drilling tool has to be applied. Similarly, the outer boreholes 26 and the contours, cutouts or recesses and surfaces define the tools to be used and the position at which the tool is to be applied.

The alignment block 22 is described by the CAD system using different functionalities in a known manner. To make the boreholes 25 and 26 in a workpiece, such as the alignment block 22, the CAD system has a first functionality suitable for making the boreholes 25 and 26. To add cutouts and/or recesses to the workpiece, a second suitable functionality is provided.

The description of the alignment block 22 thus includes a series of data 14 (illustrated in FIG. 1) which are entered in the database 15, e.g., using suitable interfaces or export and import functions. These data 14 describe, among other things, the position and the radius of the central borehole 25, e.g., in the following form:
“borehole: PosX=12, PosY=20, Rad=5”
such that the information “borehole” is determined using the functionality of the CAD system with which the central borehole 25 was created in the CAD view.

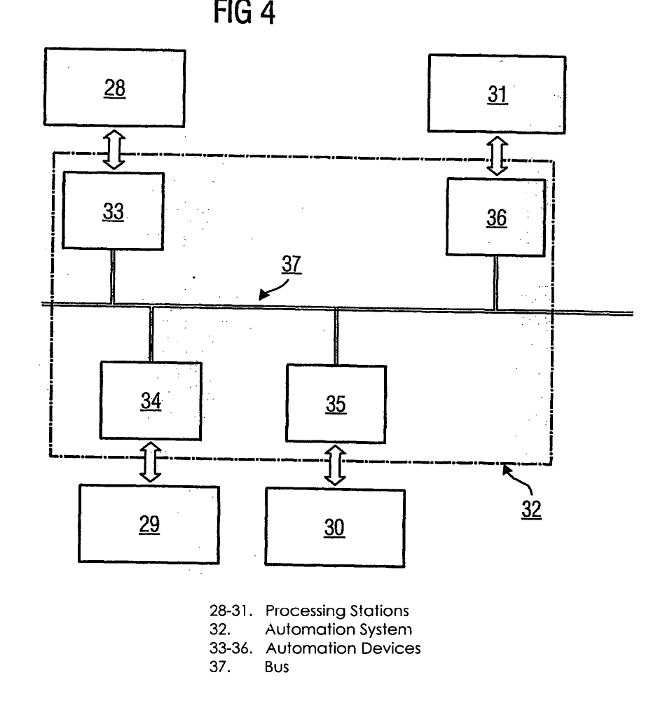

FIG. 3 shows a schematic overview of a technical process 27 used to produce workpieces, such as the described alignment block 22 illustrated in FIG. 2. The technical process 27 includes different processing stations 28, 29, 30, and 31, between which the material is transported (as indicated by the block arrows). A first processing station 28 is provided for, e.g., sawing. A subsequent second processing station 29 is provided for, e.g., drilling, and a third processing station 30 is provided for, e.g., milling. A final fourth processing station 31 is provided for, e.g., finishing the surface of the workpiece. For example, the fourth processing station 31 can be used to polish the surface of the alignment block 22 to a matte finish.

The presence of each processing stations 28-31 is known from the prior planning of the technical process 27. Likewise, the need for the presence of each processing station 28-31 can be determined from the respective technological data 14 (illustrated in FIG. 1) stored in the database 15. The presence of data 14 in the database 15 encoding a drilling process—as described above—can be used to infer the need for the presence of a processing station 29 for drilling. This inference can be readily made, even automatically by the automation tool 12. As a result, the automation tool 12 can also automatically generate a datum 14 to represent this processing station 29. Finally, with such clearly recognizable structures, the automation tool 12 can even automatically generate the link between the data 14 encoding the drilling process and the datum 14 representing the processing station 29 for drilling.

Structures that the automation tool 12 cannot detect automatically are recognized by the respective specialist based on this specialist's experience and expertise. Thus, the specialist creates data 14, which the automation tool 12 cannot automatically generate. The specialist also creates links between the individual, manually or automatically generated data 14, which the automation tool 12 cannot automatically generate. The above also applies to data 14 encoding sawing, milling, and/or polishing of the alignment block 22 and automatically generated or generatable data to represent the respective processing stations 29, 30, and 31.

FIG. 4 is a schematic representation of an automation system 32 to control and/or monitor the technical process 27 with the individual processing stations 28-31 ((illustrated in FIG. 3). The automation system 32 includes a plurality of automation devices 33, 34, 35, 36, which are communicatively interconnected in a known manner by a bus 37, e.g., by a field bus such as the Profibus. FIG. 4 illustrates that each processing station 28-31 is assigned exactly one automation device 33-36, respective. For example, automation devices 33-36 can be a programmable controller or a decentralized peripheral device for controlling and/or monitoring its respective station. The controlling and/or monitoring of the respective station are illustrated by the block arrows. In practice, however, a single automation device 33-36 can control and/monitor a plurality of processing stations 28-31, or a plurality of automation devices 33-36 can control and/or monitor individual processing stations 28-31.

Each automation device 33-36 is represented in the database 15 by a respective datum 14. A competent specialist, e.g., the automation specialist, links the one or each datum 14 representing the respective automation device, e.g., one of the devices 33-36, with respective technology-related or design-related data 14. An example of such a linkage is the link between the datum 14 representing the second processing station 29 for drilling and the automation device 34 assigned to this processing station 29. The more detailed and comprehensive the data 14 is, e.g., the data 14 representing the respective automation device (one of the devices 33-36), the more specifically the respective data 14 can be linked.

For example, if the datum 14 representing one of the automation devices 33-36 includes data structures representing the so-called process image (process image of the inputs and/or process image of the outputs), then the datum 14 encoding the drilling tool for making the central borehole 25 (illustrated in FIG. 2) in the alignment block 22 can be assigned to an output. During the subsequent automated operation of the technical process 27, this output causes the drilling tool with the appropriate diameter to be selected for making the central borehole 25. Similar assignments or links can be provided between other data 14 and the respective process inputs or outputs. The creation of these assignments or links typically falls within the scope of responsibilities of the automation specialist. These links can ultimately be used to derive even structures or fragments of a control program for controlling and/or monitoring the technical process 27. These structures or fragments of the control program are derived from the total volume of the data 14 in the database 15.

According to the exemplary, non-limiting embodiment of the present invention, an automation tool 12 is provided for supporting the planning and implementation of an automated technical process 27. The automation tool 12 has access to a database 15 containing a plurality of data 14 relating to the technical process 27. The automation tool displays a user interface 11 on a display unit, e.g., a screen 10 with a data window 13 to display the data 14 and at least one working window 16, 17, 18. Individual data 14 can be displayed in the working window 16, 17, 18 and linked with data 14 in the data window 13. This creates a content-based linkage of data that are currently isolated in the conventional automation tools. These content-based linkages of data provide the specialists involved in the planning and implementation of the technical process 27 with information regarding, for example, functional interrelations in the process. The automation tool 12 bridges the terminologies used by the specialists involved. As a result, communication problems and inconsistencies may be eliminated or at least substantially reduced.

The above description of illustrative, non-limiting embodiments has been given by way of an example. The above and other features of the invention including a device of the various novel components has been particularly described with reference to the accompanying drawings and pointed out in the claims. It will be understood that the particular construction of parts embodying the invention is shown by way of an illustration only and not as a limitation of the invention. The principles and features of this invention may be employed in varied and numerous embodiments without departing from the scope of the invention as defined by the appended claims and equivalents thereof.

1. An automation tool for supporting the planning and implementation of an automated technical process, comprising:
a module for providing access to a database, having a plurality of data relating to the technical process; and
a module for providing a user interface with a data window for displaying the data and at least one working window on a display device,
wherein individual data are displayed in the at least one working window and linked with at least one datum in the data window.

2. The automation tool as claimed in claim 1, wherein a first working window is provided to represent data relevant for a technologist.

3. The automation tool as claimed in claim 2, wherein the individual data in the at least one working window are linked with the at least one datum in the data window by using a pointer device to select the individual data in the at least one working window and move the selected data onto the at least one datum in the data window so as to link the selected data with the at least one datum in the data window.

4. The automation tool as claimed in claim 2, wherein the individual data in the at least one working window are linked with the at least one datum in the data window by using a pointer device to select the at least one datum in the data window and move the selected datum onto the individual data to be linked and that is displayed in the at least one working window.

5. The automation tool as claimed in claim 2, further comprising a suppression module for suppressing display of data not relevant to the technologist is adjusted with respect to the at least one datum in the data window.

6. The automation tool as claimed in claim 2, further comprising a suppression module for suppressing display of data not relevant to a designer is adjusted with respect to the at least one datum in the data window.

7. The automation tool as claimed in claim 2, further comprising a suppression module for suppressing display of data not relevant to an automation specialist is adjusted with respect to the at least one datum in the data window.

8. The automation tool as claimed in claim 1, wherein a second working window is provided to display data relevant to a designer.

9. The automation tool as claimed in claim 8, wherein the individual data in the at least one working window are linked with the at least one datum in the data window by using a pointer device to select the individual data in the at least one working window and move the selected data onto the at least one datum in the data window so as to link the selected data with the at least one datum in the data window.

10. The automation tool as claimed in claim 8, wherein the individual data in the at least one working window are linked with the at least one datum in the data window by using a pointer device to select the at least one datum in the data window and move the selected datum onto the individual data to be linked and that is displayed in the at least one working window.

11. The automation tool as claimed in claim 8, further comprising a suppression module for suppressing display of data not relevant to the technologist is adjusted with respect to the at least one datum in the data window.

12. The automation tool as claimed in claim 8, further comprising a suppression module for suppressing display of data not relevant to a designer is adjusted with respect to the at least one datum in the data window.

13. The automation tool as claimed in claim 8, further comprising a suppression module for suppressing display of data not relevant to an automation specialist is adjusted with respect to the at least one datum in the data window.

14. The automation tool as claimed in claim 1, wherein a further working window is provided to display data relevant to an automation specialist.

15. The automation tool as claimed in claim 14, wherein the individual data in the at least one working window are linked with the at least one datum in the data window by using a pointer device to select the individual data in the at least one working window and move the selected data onto the at least one datum in the data window so as to link the selected data with the at least one datum in the data window.

16. The automation tool as claimed in claim 14, wherein the individual data in the at least one working window are linked with the at least one datum in the data window by using a pointer device to select the at least one datum in the data window and move the selected datum onto the individual data to be linked and that is displayed in the at least one working window.

17. The automation tool as claimed in claim 14, further comprising a suppression module for suppressing display of data not relevant to the technologist is adjusted with respect to the at least one datum in the data window.

18. The automation tool as claimed in claim 14, further comprising a suppression module for suppressing display of data not relevant to a designer is adjusted with respect to the at least one datum in the data window.

19. The automation tool as claimed in claim 14, further comprising a suppression module for suppressing display of data not relevant to an automation specialist is adjusted with respect to the at least one datum in the data window.

20. The automation tool as claimed in claim 14, wherein a third working window is provided to display data relevant to an automation specialist.

21. The automation tool as claimed in claim 1, wherein the individual data in the at least one working window are linked with the at least one datum in the data window by using a pointer device to select individual data in the at least one working window and move the selected data onto the at least one datum in the data window so as to link the selected data with the at least one datum in the data window.

22. The automation tool as claimed in claim 1, wherein the individual data in the at least one working window are linked with the at least one datum in the data window by using a pointer device to select at least one datum in the data window and move the selected datum onto an individual data to be linked and that is displayed in the at least one working window.

23. The automation tool as claimed in claim 1, further comprising a suppression module for suppressing display of data not relevant to a technologist is adjusted with respect to the at least one datum in the data window.

24. The automation tool as claimed in claim 1, further comprising a suppression module for suppressing display of data not relevant to a designer is adjusted with respect to the at least one datum in the data window.

25. The automation tool as claimed in claim 1, further comprising a suppression module for suppressing display of data not relevant to an automation specialist is adjusted with respect to the at least one datum in the data window.

26. The automation tool as claimed in claim 1, wherein each of said plurality of data relates to at least one of a component or an aspect of the technical process.

27. The automation tool as claimed in claim 26, wherein the components comprise containers, pipelines, motors, valves, control elements, limit switches, working stations, automation devices, programmable controllers, and decentralized peripheral devices.

28. The automation tool as claimed in claim 26, wherein the components not used by the technical process are suppressed and not displayed in the data window.

29. The automation tool as claimed in claim 1, wherein the plurality of data is grouped according to a specialist utilizing the grouped data.

30. The automation tool as claimed in claim 29, wherein the grouped data comprises first group of data for representing the technical process to a technologist, second group of data for representing the technical process to a designer, and third group of data for representing the technological process to an automation specialist.

31. The automation tool as claimed in claim 30, wherein based on data selected by the technologist from the first group of data, the second group of data for the designer is automatically generated, and wherein based on the second group of data and modification made by the designer, the third group of data is automatically generated for use of the automation specialist, and wherein the automation specialist generates at least a segment of a control program based on the automatically generated third group of data.

32. The automation tool as claimed in claim 1, where each of the plurality of data is at least one of following types: a byte, a word, an integer, a composite data type, and a user-defined data type.

33. The automation tool as claimed in claim 1, wherein the user interface provides a specialist with a working window from the at least one working window, and wherein the window is divided spatially or functionally into a plurality of views specifically targeted for the specialist.
